(19) United States
(12) Patent Application Publication
(10) Pub. No.: US 2026/0217980 A1
(43) Pub. Date: Jul. 30, 2026

(54) ENGINEERED WOOD ADHESIVES AND ENGINEERED WOOD PRODUCT THEREFROM

(71) Applicant: CARGILL, INCORPORATED, Wayzata, MN (US)

(72) Inventors: Massimo Bregola, Castelmassa, Rome (IT); Thomas Luchsinger, Düsseldorf (DE)

(73) Assignee: CARGILL, INCORPORATED, Wayzata, MN (US)

(21) Appl. No.: 19/147,412

(22) PCT Filed: Jan. 18, 2023
(86) PCT No.: PCT/US2023/060838

§ 371 Date: Jul. 11, 2025

(51) Int. Cl. C08L 97/02; B27N 3/00; B27N 3/02; B32B 21/02; B32B 21/14; C08L 61/24

(52) U.S. Cl. CPC C08L 97/02; B27N 3/002; B27N 3/02; B32B 21/02; B32B 21/14; C08L 61/24; B32B 2250/03; B32B 2607/00

(57) ABSTRACT

An aqueous adhesive composition and a process for preparing such compositions are disclosed. The composition comprises macromolecular complex comprising (A) a first component comprising (i) a framework element and (ii) a polyphenol, and (B) second component comprising a polypeptide, oligopeptide, amino acid, or polyamine. The 5 framework element comprises (a) a polypeptide, oligopeptide, amino acid, or polyamine, (b) a polysaccharide, oligosaccharide, or monosaccharide, or a saccharide conjugate, or (c) a lignin, a lignan or a lignin conjugate. The polyphenol comprises a tannin, a tannic acid, a flavonoid, or a poly-resorcinol. An adhesive precursor composition comprising the first component is also disclosed.

### CROSS-REFERENCE TO RELATED APPLICATIONS

Not applicable

### BACKGROUND

The most commonly used wood adhesives are melamine-urea-formaldehyde resins (MUF), phenol-formaldehyde resins (PF), and urea-formaldehyde resins (UF). There are at least two concerns with MUF, PF, and UF resins, particularly when UF resins are used in external layers of a composite wood structure. First, volatile organic compounds (VOC) are generated during the manufacture and use of lignocellulosic-based composites. Additionally, there is a risk that UF resins can be subjected to hydrolysis and emit VOC even after the composite wood product is used in a final product and in the possession of a consumer. An increasing concern about the effect of emissive VOC, especially formaldehyde, on human health has prompted a need for more environmentally acceptable adhesives. Second, MUF, PF, and UF resins are made from fossil-fuel-derived products. The reserves of petroleum are naturally limited. The wood composite industry would greatly benefit from the development of formaldehyde-free adhesives that can be used to reduce the degree to which MUF, UF, and PF resins are used in a wood product.

### SUMMARY OF THE INVENTION

According to various aspects of the instant disclosure, a multi-layer engineered wood product, includes a first face layer, a second face layer; and a core layer disposed between the first face layer and the second face layer. The first face layer and the second face layer independently include a plurality of wood particles and a binder that is a reaction product of a binder reaction mixture dispersed about the plurality of wood particles. The binder reaction mixture is present in a range of from 5 parts to 20 parts per 100 parts of a dry weight of the plurality of wood particles. The binder reaction mixture and wood products together have a moisture content in a range of 5 wt % to 20 wt %. The binder reaction mixture includes an aqueous portion including a crosslinker in a range of from 20 wt % to 60 wt % based on the dry weight of the binder reaction mixture; and a polypeptide-containing component that is present in a range of from 40 wt % to 80 wt % based on the dry weight of the binder reaction mixture. The polypeptide-containing component includes a milled rapeseed flour, milled sunflower flour, or a mixture thereof. The core layer includes a urea-formaldehyde based binder, a pre-polymerized methylene diphenyl diisocyanate based binder, a polyamidoamine-epichlorohydrin resin, a melamine-urea-formaldehyde based binder, or a mixture thereof.

According to further aspects of the present disclosure, a method of making a multi-layer engineered wood product includes (a) combining a first plurality of wood particles with a polypeptide-containing component comprising a milled rapeseed flour, milled sunflower flour, or a mixture thereof to produce a first mixture. The method further includes (b) combining the first mixture produced at (a) with an aqueous formulation comprising a crosslinker to obtain a second mixture. The method further includes (c) combining a second plurality of wood particles with a urea-formaldehyde based binder, a pre-polymerized methylene diphenyl diisocyanate based binder, a polyamidoamine-epichlorohydrin resin, a melamine-urea-formaldehyde based binder, or a mixture thereof to form a third mixture. The method further includes (d) combining a third plurality of wood particles with a polypeptide-containing component comprising a rapeseed flour, sunflower flour, or a mixture thereof to produce a fourth mixture. The method further includes (e) combining the fourth mixture produced at (d) with an aqueous portion comprising a crosslinker to obtain a fifth mixture. The method further includes (f) stacking the second mixture, third mixture, and fifth mixture to form a multi-layer engineered wood precursor. The method further includes (g) curing the multi-layer engineered wood precursor, to form the multi-layer engineered wood product.

Typically, during curing, a platen is heated to a temperature in of at least 100° C., for example, at least 120° C., or at least 187° C. in a range of from 100° C. to 250° C., in a range of from 180° C. to 220° C. or in a range of from 120° C. to 190° C. In some examples, the platen is heated to achieve a curing temperature of at least 198° C., at least 204° C., at least 246° C. in a range of from 198° C. to 232° C., 204° C. to 226° C., 210° C. to 221° C., less than 315° C., or preferably less than 230° C. Typically the platen is heated to achieve a curing temperature in a range of from 204° C. to 248° C., 210° C. to 243° C., 210° C. to 226° C., at least 215° C., or at least 251° C.

Wood particles used in face layers typically have a lower average aspect ratio than the wood particles used in the core layer. Additionally, the wood particles used in face layers 102 and 104 have a smaller average particle size than the wood particles used in core layer 106.

### BRIEF DESCRIPTION OF THE FIGURES

The drawings illustrate generally, by way of example, but not by way of limitation, various embodiments of the present invention.

FIG. 1 is a side-sectional view of a multi-layer engineered wood product according to various aspects of the present patent application.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “substantially” as used herein refers to a majority of, or mostly, as in at least about 90%, 95%, 99.5%, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or about 0 wt %.

As used herein “mixture” means a portion of matter including two or more chemical substances.

According to various aspects of the instant disclosure, a multi-layer engineered wood product is described. The multi-layer engineered wood product can typically take the form of a particle board, medium density fiber board, high density fiberboard, oriented strand board, multi-layer engineered wood flooring, and combinations thereof. In some aspects, the multi-layer engineered wood can include different layers. As a non-limiting example, one layer can be a particle board and another layer or layers can be an oriented strand board. The multi-layer engineered wood product typically is sized to have any suitable dimensions. For example, the multi-layer engineered wood product typically is sized to be 1.2 meters wide and 2.6 meters long, or 1.3 meters wide and 2.1 meters long, although these values can be increased or decreased to form a multi-layer engineered wood product having desired dimensions. A thickness of the multi-layer engineered wood product typically is in a range of from 0.3 cm to 2.5 cm or 1.4 cm to 2.1 cm although these values can be increased or decreased to form a multi-layer engineered wood product having desired dimensions. These dimensions are merely meant to be examples and do not limit the sizes of multi-layer engineered wood products that typically are produced.

According to various aspects of the instant disclosure a density of the multi-layer engineered wood product typically is in a range of from 500 kg/m³ to 850 kg/m³ or from 630 kg/m³ to 750 kg/m³, or from 650 kg/m³ to 700 kg/m³.

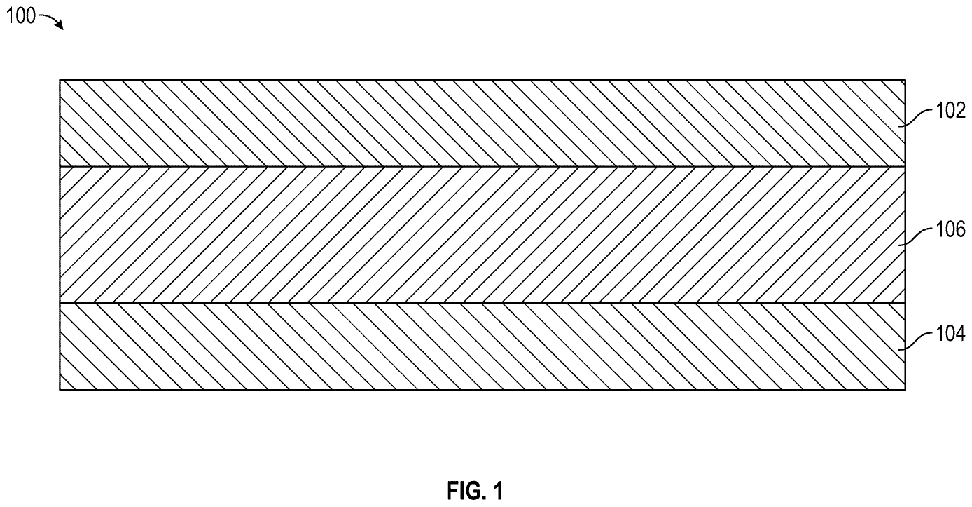

FIG. 1 is a side-sectional view of a multi-layer engineered wood product 100 according to various aspects of the present patent application. As shown in FIG. 1, multi-layer engineered wood product 100 includes first face layer 102 and second face layer 104 with core layer 106 bounded therebetween. A thickness of each of layers 102, 104, and 106 typically is the same or different. In some aspects core layer 106 accounts for 60 wt % to 80 wt % of multi-layer engineered wood product 100 or 60 wt % to 70 wt %. In some aspects first face layer 102 and second face layer 104 independently account for 20 wt % to 40 wt % of multi-layer engineered wood product 100 or 25 wt % to 30 wt %. Although three layers are shown, it is possible for multi-layer engineered wood product 100 to have additional layers. Thus, the teachings with respect to first face layer 102, second face layer 104, and core layer 106 can apply to any additional layers not specifically described herein.

First face layer 102, second face layer 104, and core layer 106 can typically include a variety of constituents. For example, first face layer 102, second face layer 104, and core layer 106 can typically individually include a plurality of wood particles bound together by a binder. According to various examples, the binder of at least one of first face layer 102 and second face layer 104 is a reaction product of a binder reaction mixture that includes a plurality of wood particles, a crosslinker that is present in the binder reaction mixture in aqueous form, and a polypeptide-containing component. By contrast, core layer 106 includes a binder that is a urea-formaldehyde based binder, a methylene diphenyl diisocyanate based binder (formed for a reaction product of a pre-polymerized methylene diphenyl diisocyanate), a polyamidoamine-epichlorohydrin resin, a melamine-urea-formaldehyde based binder, or a mixture thereof.

In the multi-layer engineered wood product, the binder that is the reaction product of the binder reaction mixture, can typically be added in any of layers 102 and 104, individually, in a range of from 3 parts to 25 parts per 100 parts of the dry weight of the wood particles of the respective layer, for example, from 5 parts to 20 parts, 6 parts to 18 parts, or 8 parts to 17 parts per 100 parts of dry weight of the wood particles of the respective layer. Having levels of binder reaction mixture in these ranges may contribute to the multi-layer engineered wood product having favorable or desirable physical properties, while effectively minimizing the amount of binder reaction mixture that is needed to bind the plurality of wood particles of the respective layers. In some aspects the chemical composition (e.g., the components of the binder reaction mixture and moisture content of the mixture of wood particles and binder reaction mixture) of each of layers 102 and 104 typically is similar (e.g., within 1% of each other). Alternatively, the chemical composition (e.g., the components of the binder reaction mixture and moisture content of the mixture of wood particles and binder reaction mixture) of any one or more of layers 102 and 104 typically is different (e.g., greater than 1% of each other). The binder of layers 102 and 104 typically is characterized as a biopolymer.

Core layer 106 can include a urea-formaldehyde resin binder or a methylene diphenyl diisocyanate binder or a polyamidoamine-epichlorohydrin resin or a melamine-urea-formaldehyde based binder. Urea-formaldehyde resin is a synthetic resin produced by the chemical combination of formaldehyde (a gas produced from methane) and urea (a solid crystal produced from ammonia). Urea-formaldehyde resins are used mostly for gluing plywood, particleboard, and other wood products. Urea-formaldehyde resins polymerize into permanently interlinked networks, which are influential in the strength of the cured adhesive. After setting and hardening, urea-formaldehyde resins form an insoluble three-dimensional network and cannot be melted or thermo-formed.

A particular benefit of the instantly described engineered wood product is that the urea-formaldehyde resin, methylene diphenyl diisocyanate binder, polyamidoamine-epichlorohydrin resin, or melamine-urea-formaldehyde based binder can be disposed in an internal layer such as core layer 106. Locating the urea-formaldehyde resin, methylene diphenyl diisocyanate binder, or melamine-urea-formaldehyde based binder in an internal layer such as core layer 106 can address a number of disadvantages associated with using these binders. For example, with respect to urea-formaldehyde, the addition of water, in high temperature, cured urea-formaldehyde can hydrolyze and release formaldehyde, this weakens the glue bond and can be toxic. Moreover, urea-formaldehyde must be used in a well-ventilated area because uncured resin is irritating and can be toxic. Additionally, urea-formaldehyde adhesives generally have a limited shelf life.

As stated herein, including the urea-formaldehyde resin, methylene diphenyl diisocyanate binder, or melamine-urea-formaldehyde based binder in core layer 106 can address at least some of these drawbacks and, in particular, prevent the outgassing of substantially any formaldehyde. This is because to whatever extent outgassing from core layer 106 occurs, if at all, the outgassing can be blocked by face layers 102 and 104. Moreover, according to various aspects, the modulus of rupture, the thickness swell %, modulus of elasticity, internal bond strength or a combination thereof of the multi-layer engineered wood can be substantially similar to a modulus of elasticity, modulus of rupture, a thickness swell %, internal bond strength or a combination thereof of a corresponding multi-layer engineered wood differing in that the reaction product exclusively uses urea-formaldehyde or a methylene diphenyl diisocyanate binder or a polyamidoamine-epichlorohydrin resin or a melamine-urea-formaldehyde based binder.

Examples of desirable physical properties of the multi-layer engineered wood products can include the product's modulus of rupture (MOR), Modulus of Elasticity (MOE), Thickness Swell Percent (Thickness swell %), Water Absorption Percent, Internal Bond Strength, or a combination thereof. The modulus of rupture of the multi-layer engineered wood product measures the amount of force required to result in rupturing the multi-layer engineered wood product. The modulus of rupture typically is measured, for example, according to European Standard (“EN”) 310, published in 1993 alternatively ASTM D 1037-06a can be used. While the modulus of rupture value can depend on a variety of factors, including the multi-layer engineered wood product's density, length, width, thickness, or a combination thereof, the modulus of rupture can generally be in a range of from 10 N/mm² to 20 N/mm² or from 11 N/mm² to 17 N/mm² or from 12 N/mm² to 14 N/mm². The upper end of the range of modulus of rupture values are surprisingly high. These higher values were determined in lab tests as demonstrated in the Examples herein, the values can be lowered to suit industrial applications if desired.

The modulus of elasticity is a quantity that measures multi-layer engineered wood product 100's resistance to being deformed elastically (e.g., non-permanently) when a stress is applied to it. The modulus of elasticity typically is measured, for example, according to EN 310, published in 1993 alternatively ASTM D 1037-06a can be used. While the modulus of elasticity value typically depends on a variety of factors, including multi-layer engineered wood product 100's density, length, width, thickness, or a combination thereof, the modulus of elasticity typically is in a range of from 1,000 N/mm² to 4,000 N/mm² or from 1,300 N/mm² to 3,500 N/mm², 1,500 N/mm² to 1,900 N/mm². The upper end of the range of modulus of elasticity values are surprisingly high. These higher values were determined in lab tests as demonstrated in the Examples herein, the values can be lowered to suit industrial applications if desired.

The thickness swell % is a quantity the measures multi-layer engineered wood product 100's resistivity to water penetration. The higher the value, the greater the amount of water that is penetrated. This can result in multi-layer engineered wood product 100 swelling or otherwise deforming. For example, multi-layer engineered wood product 100 may expand past a desired amount. This typically is undesirable, if multi-layer engineered wood product 100 has precise features such as bore holes, flanges, grooves, or the like, that are designed to fit precisely with a corresponding feature on another product. The thickness swell % value typically is measured, for example, according to EN 317, published in 1993, alternatively, ASTM D 1037-06a can be used. According to some aspects, the thickness swell % after soaking multi-layer engineered wood 100 in water for two hours typically is as low as zero. However, other acceptable values include those in a range of from 5% to 40%, from 5% to 35%, from 15% to 35%, or from 20% to 35%, measured after soaking the multi-layer engineered wood product in water for two hours. According to some additional aspects, the thickness swell % after soaking the multi-layer engineered wood in water for twenty-four hours typically is as low as zero. However, other acceptable values include those in a range of from 5% to 50%, from 15% to 45%, from 20% to 40%, or from 30% to 35%, measured after soaking the multi-layer engineered wood product in water for twenty-four. As mentioned herein below, the thickness swell % can be improved by optionally including a wax additive to the binder reaction mixture of first face layer 102, second face layer 104, core layer 106, or a combination thereof. The wax additive can lower the internal bond strength of the multi-layer engineered wood product, although the degree to which it is reduced is typically not significant.

The internal bond strength is a quantity that measures the strength of an article to resist rupturing in a direction perpendicular to the surface of the article. The internal bond strength typically is measured, for example, by EN 319, published in 1993, alternatively, ASTM D 1037-06a can be used. According to some aspects, the internal bond strength of multi-layer engineered wood product 100 typically is in a range of from 0.3 N/mm² to 0.7 N/mm² or from 0.2 N/mm² to 0.7 N/mm² or from 0.4 N/mm² to 0.6 N/mm².

A benefit of using multi-layer engineered wood products formed using the materials and methods described herein, is that the properties of the multi-layer engineered wood products, typically are generally comparable to those of a corresponding multi-layer engineered wood product differing in that it exclusively uses a urea-formaldehyde (UF) binder.

The properties of the multi-layer engineered wood products described herein typically is further achieved or enhanced, for example, by distributing the binder reaction mixture such that it is substantially homogenously distributed about the plurality of wood particles. Other properties such as the thickness swell % can typically be achieved or enhanced by adding a swell-retardant agent to the binder reaction mixture such that it is distributed about the multi-layer engineered wood product. The swell-retardant agent can include a wax emulsion that can sustain (e.g., remain stable) for a suitable amount of time. Where present, the swell-retardant typically is from 0.1 wt % to 1 wt % or from 0.5 wt % to 0.7 wt % of the multi-layer engineered wood product. In further aspects the swell-retardant can be at least partially coated over an external portion of first face layer 102, second face layer 104, or both as opposed to being incorporated into the binder reaction mixture. In still further aspects, the swell-retardant can be first added to the binder reaction mixture before the binder reaction mixture is contacted with the plurality of wood products. In such a case, the swell-retardant will additionally act as lubricant for combining the aqueous portion of the binder reaction mixture and the plurality of wood particles.

Multi-layer engineered wood product 100 described herein is formed from a multi-layer engineered wood precursor mixture. Within the multi-layer engineered wood precursor mixture, a first binder reaction mixture is used to form first face layer 102 and second face layer 104 and a second binder reaction mixture is used to form core layer 106. The plurality of wood particles in any of first face layer 102, second face layer 104, or core layer 106, can include one or more wood particles or one or more wood strands. The wood particles can include a wood material such as pine, hemlock, spruce, aspen, birch, maple, oak, cedar, ash, beech, or mixtures thereof. The wood particles or strands can include virgin wood particles or strands, recycled wood particles or strands, or a mixture thereof. According to various aspects, the plurality of wood particles of the first face layer 102 and the second face layer 104 have an average major dimension that is smaller than the average major dimension of the wood particles of the core layer. Furthermore, individual wood particles of the plurality of wood particles comprise an aspect ratio (length:width) that is greater than 1. With respect to the wood particles of first face layer 102 and second face layer 104, the wood particles can independently have a width in a range of from 0.5 mm to 1.5 mm, 0.6 mm to 1 mm, or 0.7 to 0.9 mm and can independently have a length in a range of from 1 mm to 5 mm, 2 mm to 5 mm, or 3 mm to 5 mm. With respect to the wood particles of core layer 106, the wood particles can independently have a width in a range of from 1.5 mm to 5 mm, 1.5 mm to 3 mm, or 2 to 3 mm and can independently have a length in a range of from 5 mm to 15 mm, 8 mm to 12 mm, or 9 mm to 12 mm. Smaller wood particles in face layers 102 and 104 can help to improve the aesthetic qualities of the multi-layer engineered wood product 100 by having finer grains than core layer 106, which is not visible.

In some aspects, core layer 106 typically includes comparatively larger wood particles than those of face layers 102 and 104. Where present, the larger wood particles of core layer 106 overcome expected disadvantages of using the smaller wood particles of face layers 102 and 104. For example, using smaller wood particles such as those of face layers 102 and 104 is typically disfavored because one of ordinary skill would expect that a larger binder dose is needed to provide adequate physical properties, compared to when larger wood particles are used. However, because core layer 106 uses the larger wood particles, the degree to which excess levels of binder is used in face layers 102, 104, or both can be offset by the comparatively less amount of binder used in core layer 106, thus making the total amount of binder material in multi-layer engineered wood product 100 less than a comparative multi-layer engineered wood product 100 in which each layer includes the wood particles of face layers 102 and 104. Moreover, the ability of multi-layer engineered wood product 100 to use a comparatively cheaper binder in core layer 106 such as a urea-formaldehyde based binder, a pre-polymerized methylene diphenyl diisocyanate based binder, a polyamidoamine-epichlorohydrin resin, a melamine-urea-formaldehyde based binder, or a mixture thereof, typically results in cost savings, while allowing for the inclusion of the smaller—more aesthetically desirable—wood particles in face layers 102 and 104.

The aqueous portion of the binder reaction mixture has an initial viscosity (prior to curing) at 22° C. of 150 mPas to 250 mPas, from 160 mPas to 180 mPas. Viscosity is measured using a Brookfield DVI viscometer, available from Brookfield Ametek. The viscosity of the aqueous portion of the binder reaction mixture is at a level that will allow it to be sprayed through a typical spray nozzle known in the art. Depending on the spray nozzle used, the viscosity can be higher than 250 mPas at 22° C.

Where present in any of first face layer 102, second face layer 104, as stated herein above, the binder reaction mixture can typically be added in a range of 5 to 20 parts per one hundred (100) parts of the dry weight of the wood particles of the respective layer. As used herein the “parts” of the binder reaction mixture refer to dry parts of the binder reaction mixture. The binder reaction mixture of first face layer 102 and second face layer 104, can typically include a crosslinker and a polypeptide-containing component. The polypeptide containing component typically is distributed about wood particle followed by applying the crosslinker (e.g., by spraying) to the wood particles. A dry solids content of the binder reaction mixture of first face layer 102, the binder reaction mixture of the second face layer 104, or both are in a range of from 50% to 90% from 55% to 85%, or from 60% to 80%. The moisture content of face layers 102 and 104 can be adjusted to a desired level by adding water. A dry solids content of the binder reaction mixture of core layer 106 is in a range of from 50% to 100%, 60% to 90% of 70% to 90%.

The crosslinker typically is in an aqueous form in a range of from 20 wt % to 60 wt % based on a dry weight of the binder reaction mixture or from 30 wt % to 40 wt %. The crosslinker can be a polyaminopolyamide-epichlorohydrin-based compound. An example of a suitable crosslinker can include a polyamidoamine-epichlorohydrin resin available under the tradename SOYAD CL4740 EU, from Solenis, Ijssel, Netherlands. The aqueous solution that the crosslinker is dispersed in can have a pH greater than 2 and less than 7, for example from 3 to 6 or from 3.5 to 4.5.

The multi-layer engineered wood precursor mixture further includes a polypeptide-containing component distributed about the crosslinker and wood particle. The concentration of polypeptide-containing component is measured based on the dry weight of the binder reaction mixture. The concentration of the polypeptide-containing component can typically be in a range of from 40 wt % to 80 wt %, 50 wt % to 70 wt %, or 60 wt % to 65 wt %.

The polypeptide-containing component can typically include a protein sourced from a vegetable. For example, the protein typically is milled rapeseed flour, milled sunflower flour, or a mixture thereof. A protein content of the polypeptide-containing component sourced from rapeseed and even sunflower can be in a range of from 20 wt % to 45 wt % of the polypeptide-containing component, 25 wt % to 40 wt % of the polypeptide-containing component, or 27 wt % to 37 wt % of the polypeptide-containing component. Surprisingly and unexpectedly, engineered wood products 100 that include “low” protein containing milled flours such as those sourced from rapeseed and sunflower perform at least equivalently to comparatively “high” protein content polypeptide-containing materials (e.g., greater than 50 wt %) such as a soy flour or corn flour. Moreover, it has been found that materials such as a milled rapeseed expeller cake or a milled maize gluten meal work surprisingly well given their high oil content (15-25 wt %). In some examples, milling the rapeseed expeller cake or a milled maize gluten meal can occur at very low temperatures such as −70° C. Other rapeseed flours such as defatted rapeseed flours do not need to be milled at such low temperatures, which can make them preferable to use in some examples. The milled rapeseed flour, milled sunflower flour, or the mixture thereof can have a protein dispersibility index of at least 3%. For example, a protein dispersibility index of the milled rapeseed flour or milled sunflower flour typically is in a range of from 3% to 95%, for example a PDI from 50% to 95%, 4% to 50%, 4% to 37%. The PDI is determined as explained herein at Example 2. Milling is performed as explained herein at Example 3.

If it is desired to screen the polypeptide-containing component by size, the component typically is selected from one that passes through a screen sized 100-mesh screen to a 635-mesh screen or a 100-mesh screen to a 400-mesh screen, for example a screen size typically is from 150 to 325. The milled rapeseed flour, milled sunflower flour, or the mixture thereof can be processed to have a certain size or distribution of sizes. For, example a d95 of a distribution of particles of the milled rapeseed flour, milled sunflower flour, or the mixture thereof can range from 50 μm to 120 μm, 60 μm to 98 μm, or 70 μm to 80 μm. A d10 of the distribution of particles of the milled rapeseed flour, milled sunflower flour is less than 5 μm, less than 4 μm, and preferably less than 3 μm. As used herein the term “d95” means that 95% of the particles in the distribution of particles are smaller than the d95 value. As used herein the term “d10” means that 10% of the particles in the distribution of particles are smaller than the d10 value. The d95 values, d10 values, or both can be determined using any of the instruments mentioned herein at Example 3.

As described previously, first face layer 102 and second face layer 104 are substantially free of a urea-formaldehyde binder or a methylene diphenyl diisocyanate binder or a melamine-urea-formaldehyde based binder. Therefore, the multi-layer engineered wood precursor mixtures described herein that form first face layer 102 and second face layer 104 are also free of a urea-formaldehyde binder or a methylene diphenyl diisocyanate binder or a melamine-urea-formaldehyde based binder. For example, the respective mixture can typically include less than 5 wt % of urea-formaldehyde or a methylene diphenyl diisocyanate binder or a melamine-urea-formaldehyde based binder or be substantially free (e.g., include less than 1 wt %) of urea-formaldehyde or a methylene diphenyl diisocyanate or a melamine-urea-formaldehyde based binder. To the contrary, core layer 106 can include a urea-formaldehyde binder or a methylene diphenyl diisocyanate binder or a melamine-urea-formaldehyde based binder.

The moisture content of a mixture of the binder reaction mixture and the plurality of wood particles, prior to curing, used to form each of first face layer 102, second face layer 104, and core layer 106 typically is carefully controlled. For example, the moisture content of the mixture of the wood particles and the binder reaction mixture in each of layers 102 and 104 typically is in a range of at least 4 wt % to 20 wt %, or from 5% to 15%, or 10% to 14%. The moisture content of the mixture of the binder reaction mixture and the plurality of wood particles, prior to curing, used to form core layer 106 is in a range of from 2 wt % to 15 wt %, or from 3 wt % to 15 wt %, or from 4 wt % to 6 wt %.

The moisture content can affect the ability to disperse the components of the binder reaction mixture about the wood particles. The moisture content typically is tuned, for example by increasing or decreasing the moisture content in the binder reaction mixture. For example, if the moisture content in the wood particles is low, the moisture content in the binder reaction mixture typically is increased to bring the total moisture content of the mixture of the binder reaction mixture and plurality of wood particles to a desired level. In some aspects, moisture typically is added to the mixture of the wood particles and the binder reaction mixture by spraying water to the binder reaction mixture distributed on the wood particles. However, in certain aspects, water can simply be added to the plurality of wood particles before the crosslinker is added. According to various aspects, this can give better distribution of the moisture across the mixture of binder reaction mixture and wood particles. Optionally, the moisture content can be increased by adding water to the aqueous portion of the binder reaction mixture.

Multi-layer engineered wood product 100 described herein typically is made or manufactured according to many suitable methods. As an example, a method can include (a) combining a first plurality of wood particles with the polypeptide-containing component (including, e.g., a milled rapeseed flour, milled sunflower flour, or a mixture thereof to produce a first mixture.

After the first mixture of (a) is formed, the method can further include (b) combining the first mixture produced at (a) with a crosslinker to produce a second mixture. To help to achieve a uniform blend, combining at (b) is typically performed by spraying the crosslinker to the plurality of wood particles. The spraying and combining can typically occur for a time in a range of from 1 minute to 60 minutes or 1 minute to 10 minutes.

The method further includes (c) combining a second plurality of wood particles with a urea-formaldehyde based binder, a methylene diphenyl diisocyanate based binder, a polyamidoamine-epichlorohydrin resin, a melamine-urea-formaldehyde based binder, or a mixture thereof to form a third mixture. The urea-formaldehyde based binder, the methylene diphenyl diisocyanate based binder, the polyamidoamine-epichlorohydrin resin, a melamine-urea-formaldehyde based binder, or the mixture thereof can be sprayed to the second plurality of wood chips.

The method further includes (d) combining a third plurality of wood particles with a polypeptide-containing component (including, e.g., a milled rapeseed flour, milled sunflower flour, or a mixture thereof) to produce a fourth mixture. In some aspects, the fourth mixture can be milled (e.g., using a mechanical impact mill) to bring the milled rapeseed flour particles to a desired size or distribution of sizes.

The method further includes (f) stacking the second mixture, third mixture, and fifth mixture to form a multi-layer engineered wood precursor. Once stacked, the second mixture corresponds the first face layer 102, the third mixture corresponds to the core layer 106, and the fifth mixture corresponds to the second face layer 102. The multi-layer engineered wood precursor can also be referred to as a “green structure”. The tack strength of the green structures helps to allow the green structures to remain relatively intact when stacked.

Once the green structure is formed, the green structure is cured. Curing can include hot pressing the green structure. Hot pressing is performed at a pressure of at least 0.34 N/mm² and at most 3.44 N/mm², from 0.34 N/mm² to 3.1 N/mm², or from 0.20 N/mm² to 2.75 N/mm². The pressure used typically is selected at least in part to achieve a certain thickness of the multi-layer engineered wood product. In addition to the pressure, a platen of the press used for hot pressing at is heated to a temperature in a range of at least 150° C., for example, at least 180° C., or at least 190° C. in a range of from form 204° C. to 248° C., 180° C. to 240° C., or in a range of from 190° C. to 230° C., or in a range of 190° C. to 220° C. The method can further include a “cold pressing” step that can occur before or after the hot pressing. Cold pressing can occur at ambient temperatures.

“Combining” as used herein can include many combination techniques know to one of ordinary skill, for example combining can include mixing components (for example, stirring components), spraying a component to contact another component, or the like.

### EXAMPLES

Various aspects of the present disclosure can be better understood by reference to the following Examples, which are offered by way of illustration. The present disclosure is not limited to the Examples given herein. Unless indicated to the contrary, mixtures of the wood components and the binder reaction mixtures used in the examples had a moisture content (e.g., a mat moisture content prior to curing) of from five percent by weight (5 wt %) to twenty weight percent (20 wt %) and preferably from nine percent by weight to fifteen percent. Additionally, unless indicated to the contrary, “wt %”, used for example to describe wt % crosslinker, wt % rapeseed flour, wt % sunflower flour, etc. refer to dry weight percent of the indicated component based on the total dry weight of the binder reaction mixture.

TABLE 1

| Name | Supplier |
|---|---|
| Face Layer Wood | Wood Particles having an average aspect ratio |
| Particles (FLWP) | (length:width) of greater than 1:1. Wood |
| | particles used in the face layer are mainly |
| | pine with spruce, poplar, and beech. An |
| | average particle size is 0.7 mm wide × 2.5 |
| | mm long. |
| Core Layer Wood | Wood Particles having an average aspect ratio |
| Particles (CLWP) | (length:width) of greater than 1:1. Wood |
| | particles used in the core layer are mainly |
| | pine with spruce, poplar, and beech. An |
| | average particle size is 2 mm wide × 10 mm |
| | long. |
| Prolia 200/90 | A soy flour having a protein content of 52.5 |
| | wt %, a 200 mesh particle size and a protein |
| | dispersibility index (PDI) of 93.9, available |
| | from Cargill, Incorporated, Wayzata, MN |
| Prolia 200/20 | A soy flour having protein content of 51 wt %, |
| | a 200 mesh particle size and a protein |
| | dispersibility index (PDI) of 34.4, available |
| | from Cargill, Incorporated, Wayzata, MN |
| Prolia 200/70 | A soy flour having protein content of 50.2 |
| | wt %, a 200 mesh particle size and a protein |
| | dispersibility index (PDI) of 77.8, available |
| | from Cargill, Incorporated, Wayzata, MN. |
| Rapeseed Expeller | A milled rapeseed flour having a protein |
| Cake Flour (REC) | content of 27.4 wt % and a protein |
| | dispersibility index (PDI) of 36.7, produced |
| | by Cargill Deutschland GmbH, Riesa, |
| | Germany. |
| Rapeseed White | A milled rapeseed flour having a protein |
| Flake Flour (RWF) | content of 36.5 wt % and a protein |
| | dispersibility index (PDI) of 35.5, produced |
| | by Cargill Deutschland GmbH, Riesa, |
| | Germany. |
| Rapeseed Meal | A milled rapeseed meal having a protein |
| Flour (RM) | content of 36.0 wt % and a protein |
| | dispersibility index (PDI) of 14.4, produced |
| | by Cargill Deutschland GmbH, Riesa, |
| | Germany |
| Sunflower Meal | A milled sunflower meal having a protein |
| Flour (SM) | content of 39.6 wt % and a protein |
| | dispersibility index (PDI) of 10.5, produced |
| | by Cargill France. |
| Maize Gluten | A milled corn meal having a protein content |
| Meal (MGM) | of 60.2 wt % and a protein dispersibility index |
| | (PDI) of 4.5, produced by Cargill BV, |
| | Netherlands. |
| Sopro UTB 200 | A soybean flour having a protein content of |
| | 54.4 wt % and a protein dispersibility index |
| | (PDI) of 81.4, available from Victoria Mills, |
| | Becej, Serbia. |
| Full Fat | A soy flour having a protein content of 38.4 |
| Soybean Flour | wt % and a protein dispersibility index (PDI) |
| | of 32.0, produced by Cereal Docks Group, |
| | Camisano Vicentino, Italy. |
| Ammonium | An ammonium sulfate, available from Merck |
| Sulfate (AS) | Chemicals, Darmstadt, Germany. |
| CL4740 | A polyamide-epichlorohydrin based |
| | crosslinker available under the tradename |
| | SOYAD CL4740 EU, from Solenis, Ijssel, |
| | Netherlands. |
| UF | A urea formaldehyde glue, available under |
| | the trade designation KAURIT K 340 S, |
| | available from BASF SE, Ludwigshafen |
| | Germany. |
| pMDI | A pre-polymerized methylene diphenyl |
| | diisocyanate viscosity in a range of from 110 |
| | mPa*s to 650 mPa* measured at 25° C., |
| | available from BASF SE, Ludwigshafen |
| | Germany. |

### Example 1

A pre-weighed amount of water (W_{A}) and crosslinker are mixed to form an aqueous portion. The aqueous portion of the binder reaction mixture is placed on a shaker for 5 minutes. With respect to the W_{A}, the total water content of the binder and wood particle (WP) is targeted at 9 wt % to 15 wt %. The ratio of the dry binder to dry wood particle is 5:100 (e.g., 5 parts per 100 parts of dry WP) to 20:100 (e.g., 20 parts per 100 parts of dry WP). The water content to be added to the aqueous portion of the binder reaction mixture is calculated based on the third mixture moisture content, the wood particle moisture and total binder moisture content.

The moisture content of the wood particles, crosslinker, and polypeptide-containing component are measured by a Mettler Toledo moisture balance at 130° C. W_{A} is determined according to Equation 1:

$${W}_{A} = {W}_{T} - {W}_{WP} - {W}_{BF} \qquad ( Equation 1 )$$

W_{A}: Water to be added to the aqueous portion of the binder reaction mixture
W_{T}: Total moisture of the mixture of wood particles and components
W_{WP}: Water in wood particle
W_{BF}: Water in the binder ingredients including water in crosslinker and polypeptide-containing component.

### Example 2

Protein dispersibility index (PDI) values for RM, SM, REC, and RWF are determined according to the following protocol. 10 g (+/−0.1 g) of polypeptide-containing component (RM, SM, REC, or RWF) having a known protein concentration (which correlates to “% total protein” in Equation 1) are weighed and placed in a 50 ml beaker. A graduated cylinder with 150 ml of distilled water is prepared. 50 ml of the water is poured in a blender (e.g., a Vitamix Blender, available from Vitamix INC, Olmsted Falls OH), at room temperature. The polypeptide-containing component is added to the Vitamix blender and mixed with a spatula to produce a paste. Remainder water from the beaker is added to the blender in increments, while stirring with the spatula, to form a smooth slurry, a portion of the remaining water is used to rinse the spatula and the mixer walls. The blender is activated and its speed is slowly increased to 9000 revolutions-per-minute (rpm) where mixing occurs for 5 minutes. The resulting suspension is poured into a 400 ml beaker and left to separate the sediment (if possible). A 50 mL portion of the decanted solution is placed in a 50 ml conical tube. The conical tube is centrifuged at 2700 rpm for 10 min. Following centrifugation, the supernatant is separated into another 50 ml conical tube to and stored at 4° C. overnight. Following storage, the percent total nitrogen (which correlates to the “% water dispersible protein” in Equation 1) of the supernatant is measured in triplicate using an elemental analysis instrument (e.g., an elemental analysis instrument available from LECO, Corporation St. Joseph MI).

PDI is calculated using the Equation 1 below:

$$Protein Dispersibility Index ( PDI ) = \frac{\% water dispersible protein \times 100}{\% total protein} \qquad ( 1 )$$

PDI of the soy-based polypeptide components is calculated by weighing a 10 g±0.1 g test portion of the soy-based polypeptide having a known protein concentration (which correlates to “% total protein” in Equation 1) component. 150 mL of distilled water is added to a graduated cylinder. 50 mL of the water is poured into the mixer cup. The weighed test portion is transferred quantitatively to the mixer cup. The test portion is stirred with a spatula to form a paste. The remainder of water is added in increments, with stirring, to form a smooth slurry, using any remining water to rinse spatula and mixer cup walls. The cup is placed in position for blending. Blending occurs at a speed of 8,500 rpm for 10 min. Following mixing, the mixer cup is removed and the slurry is poured into a 400 ml beaker. After the slurry has separated, a portion is decanted into a 50 mL centrifuge tube and centrifuged for 10 min at 2,700 rpm. The protein content of the supernatant (which correlates to the “% water dispersible protein” in Equation 1) is determined by either Kjeldahl or Dumas procedures (15 mL=1.0 g test portion). The PDI is calculated using Equation 1.

### Example 3

Materials such as REC, RWF, RM, SM and MGM are milled prior to use in forming the multi-layer engineered wood product. Milling is accomplished using a mechanical impact mill (e.g., UPZ Ultraplex™ fine impact mill, available from Hosokawa Alpine, Augsburg Germany). In order to avoid blockage of the mill when using REC or MGM, the milling temperature is reduced to −70° C. A mechanical impact mill with integrated classifier (e.g., Zirkoplex™ classifier mill, available from Hosokawa Alpine, Augsburg Germany) is used for samples RWF, RM and SM. Mill speed and classifier speed are adjusted in order to obtain the desired particle size distribution of the specific material. A person skilled in the art can determine grinding set up an parameters without undue experimentation. Results from the milling are presented below in Table 2.

TABLE 2

| | |
|---|---|
| Initial Meal | Milled Flour |

| Code | d90 [μm]* | Code | d95 [μm]** |
|---|---|---|---|
| REC | 5763 | REC | 74.6 |
| RWF | 5599 | RWF | 80.1 |
| RM | 4972 | RM | 62.4 |
| SM | 595 | SM | 72.0 |
| MGM | 1311 | MGM | 97.6 |

*measured with Alpine Air Jet Sieve e200LS ™, available from Hosokawa Alpine, Augsburg Germany
**measured with a Sympatec HELOS 5 Device, available from Sympatec GmbH, DE.

### Example 4

Binder compositions including the components as shown in Table 3 are tested in a lab environment by producing three layered particle board panels of dimensions 460 mm long×440 mm wide. The three layers include two face layers (e.g., first face layers 102 and 104) with a core layer (e.g., core layer 106) disposed therebetween.

Core layer wood particles used to form the core layer are resinated with a common urea formaldehyde glue (e.g., Kaurit K 340 S, BASF SE, Ludwigshafen Germany). Core layer wood particles are homogenized in a blender with rotating arms (e.g., Lödige blender, available from Bickel & Wolf GmbH, Purkesdorf Austria). The amount of water required to obtain resinated particles with a moisture content of 6%, as calculated according to Example 1, is sprayed onto the chips while continuously blending. Urea formaldehyde resin having a dry matter content of 65% is sprayed together with 2 parts dry ammonium sulfate (AS) per 100 parts dry urea formaldehyde and 4.5 parts dry urea per 100 parts dry urea formaldehyde onto the wood particles to a final dry binder dose of 6.5 parts per 100 parts dry wood particle.

Face layer wood particles are resinated with a two-component glue including a milled vegetable flour (e.g., rapeseed meal, rapeseed white flakes, Prolia 200/90, etc) and a CL4740 crosslinker. The wood chips are homogenized in a blender with rotating arms (e.g., Lödige blender, available from Bickel & Wolf GmbH, Purkesdorf Austria). The calculated amount of dry vegetable flour is added at a dose of 5.5 or 7.5 parts per 100 parts dry wood particles. After about 30 seconds of blending, the calculated amount of crosslinker is sprayed on the face layer wood particles and vegetable flour mixture while blending. Wood particle moisture is adjusted by spraying additional water in order to achieve the calculated target moisture level of 12%, as calculated above with respect to Example 1.

TABLE 3

| | Face Layer | Face Layer | Core Layer | Core Layer |
|---|---|---|---|---|
| Example | Component 1 | Component 2 | Component 1 | Component 2 |
| 1.1 | 10 parts dry UF | 2 parts dry AS | 6.5 parts dry | 2 parts dry AS per 100 |
| | per 100 parts dry | per 100 parts | UF per 100 | parts dry UF and 4.5 |
| | wood particles | dry UF | parts dry wood | parts dry Urea per 100 |
| | | | particle | parts dry UF |
| 1.2 | 5.5 parts dry REC | 3.5 parts dry | 6.5 parts dry | 2 parts dry AS per 100 |
| | per 100 parts dry | CL 4740 per | UF per 100 | parts dry UF and 4.5 |
| | wood particles | 100 parts dry | parts dry wood | parts dry Urea per 100 |
| | | wood particles | particles | parts dry UF |
| 1.3 | 5.5 parts dry | 3.5 parts dry | 6.5 parts dry | 2 parts dry AS per 100 |
| | RWF per 100 | CL 4740 per | UF per 100 | parts dry UF and 4.5 |
| | parts dry wood | 100 parts dry | parts dry wood | parts dry Urea per 100 |
| | particles | wood particles | particles | parts dry UF |
| 1.4 | 7.5 parts dry | 3.5 parts dry | 6.5 parts dry | 2 parts dry AS per 100 |
| | RWF per 100 | CL 4740 per | UF per 100 | parts dry UF and 4.5 |
| | parts dry wood | 100 parts dry | parts dry wood | parts dry Urea per 100 |
| | particles | wood particles | particles | parts dry UF |
| 1.5 | 5.5 parts dry RM | 3.5 parts dry | 6.5 parts dry | 2 parts dry AS per 100 |
| | per 100 parts dry | CL 4740 per | UF per 100 | parts dry UF and 4.5 |
| | wood particles | 100 parts dry | parts dry wood | parts dry Urea per 100 |
| | | wood particles | particles | parts dry UF |
| 1.6 | 5.5 parts dry SM | 3.5 parts dry | 6.5 parts dry | 2 parts dry AS per 100 |
| | per 100 parts dry | CL 4740 per | UF per 100 | parts dry UF and 4.5 |
| | wood particles | 100 parts dry | parts dry wood | parts dry Urea per 100 |
| | | wood particles | particles | parts dry UF |
| 1.7 | 5.5 parts dry | 3.5 parts dry | 6.5 parts dry | 2 parts dry AS per 100 |
| | MGM per 100 | CL 4740 per | UF per 100 | parts dry UF and 4.5 |
| | parts dry wood | 100 parts dry | parts dry wood | parts dry Urea per 100 |
| | particles | wood particles | particles | parts dry UF |
| 1.8 | 5.5 parts dry | 3.5 parts dry | 6.5 parts dry | 2 parts dry AS per 100 |
| | Prolia 200/90 per | CL 4740 per | UF per 100 | parts dry UF and 4.5 |
| | 100 parts dry | 100 parts dry | parts dry wood | parts dry Urea per 100 |
| | wood particles | wood particles | particles | parts dry UF |
| 1.9 | 5.5 parts dry | 3.5 parts dry | 6.5 parts dry | 2 parts dry AS per 100 |
| | Prolia 200/70 per | CL 4740 per | UF per 100 | parts dry UF and 4.5 |
| | 100 parts dry | 100 parts dry | parts dry wood | parts dry Urea per 100 |
| | wood particles | wood particles | particles | parts dry UF |
| 1.10 | 5.5 parts dry | 3.5 parts dry | 6.5 parts dry | 2 parts dry AS per 100 |
| | Prolia 200/20 per | CL 4740 per | UF per 100 | parts dry UF and 4.5 |
| | 100 parts dry | 100 parts dry | parts dry wood | parts dry Urea per 100 |
| | wood particles | wood particles | particles | parts dry UF |

In another Example multi-layer particle boards are produced as described herein above with the exception that the core layer does not include the urea formaldehyde binder but instead includes a pre-polymerized methylene diphenyl diisocyanate (pMDI) based binder. Compositions with the core layer including pMDI are shown below in Table 3. The resulting multi-layer boards are expected to have similar physical properties to the multi-layer boards as described in Table 5, where the multi-layer boards include a UF binder in the core.

TABLE 4

| | Face Layer | Face Layer | Core Layer |
|---|---|---|---|
| Example | Component 1 | Component 2 | Component 1 |
| 1.11 | 10 parts dry UF | 2 parts dry AS | 3 parts dry |
| | per 100 parts dry | per 100 parts | pMDI per 100 |
| | wood particles | dry UF | parts dry wood |
| | | | particle |
| 1.12 | 5.5 parts dry REC | 3.5 parts dry | 3 parts dry |
| | per 100 parts dry | CL 4740 per | pMDI per 100 |
| | wood particles | 100 parts dry | parts dry wood |
| | | wood particles | particles |
| 1.13 | 5.5 parts dry | 3.5 parts dry | 3 parts dry |
| | RWF per 100 | CL 4740 per | pMDI per 100 |
| | parts dry wood | 100 parts dry | parts dry wood |
| | particles | wood particles | particles |
| 1.14 | 7.5 parts dry | 3.5 parts dry | 3 parts dry |
| | RWF per 100 | CL 4740 per | pMDI per 100 |
| | parts dry wood | 100 parts dry | parts dry wood |
| | particles | wood particles | particles |
| 1.15 | 5.5 parts dry RM | 3.5 parts dry | 3 pards dry |
| | per 100 parts dry | CL 4740 per | pMDI per 100 |
| | wood particles | 100 parts dry | parts dry wood |
| | | wood particles | particles |
| 1.16 | 5.5 parts dry SM | 3.5 parts dry | 3 parts dry |
| | per 100 parts dry | CL 4740 per | pMDI per 100 |
| | wood particles | 100 parts dry | parts dry wood |
| | | wood particles | particles |
| 1.17 | 5.5 parts dry | 3.5 parts dry | 3 parts dry |
| | MGM per 100 | CL 4740 per | pMDI per 100 |
| | parts dry wood | 100 parts dry | parts dry wood |
| | particles | wood particles | particles |
| 1.18 | 5.5 parts dry | 3.5 parts dry | 3 parts dry |
| | Prolia 200/90 per | CL 4740 per | pMDI per 100 |
| | 100 parts dry | 100 parts dry | parts dry wood |
| | wood particles | wood particles | particles |
| 1.19 | 5.5 parts dry | 3.5 parts dry | 3 parts dry |
| | Prolia 200/70 per | CL 4740 per | pMDI per 100 |
| | 100 parts dry | 100 parts dry | parts dry wood |
| | wood particles | wood particles | particles |
| 1.11 | 5.5 parts dry | 3.5 parts dry | 3 parts dry |
| | Prolia 200/20 per | CL 4740 per | pMDI per 100 |
| | 100 parts dry | 100 parts dry | parts dry wood |
| | wood particles | wood particles | particles |

Boards with three layers (two face layers bounding a core layer) are prepared. Two external layers include resinated face layer wood particles, each external layer representing 15% of the total weight of the final board and one core layer including resinated core layer particles representing 70% of the total weight of the final board.

A green structure is formed by manually spreading resinated face layer particles and resinated core layer particles into a wooden frame having dimensions of 460 mm×440 mm. Specifically, a first layer of resinated face layer wood particles is spread into the frame, a layer of reinstated core layer wood particles is spread onto the first face layer, and a second layer of resinated face layer wood particles is onto the reinstated core layer wood particles, each spread at amounts to obtain a panel of 17 mm thickness and density of 650 kg/m³.

The green structure is prepressed at room temperature (~25° C.) to form a pre-condensed mat. This pre-condensed mat is then transferred to the opened heated press and 17 mm thick iron plates are disposed on the sides to fix the final board thickness. The plate temperature of the press is set at 210° C. and the press factor applied was 10 s/mm to form the multi-layer boards.

After conditioning the multi-layer boards for one week at 20° C. and 65% relative humidity (r.h.), test specimens are cut according to the EN 326-1 standard, published in 1994. Specimens are again conditioned for one week at 20° C. and 65% relative humidity (r.h.), before testing. The multi-layer boards were 460 mm long×440 mm wide×17.5 mm thick. The multi-layer boards were sanded to a thickness of 16 mm. The target density of the multi-layer boards was 650 kg/m³+/−10 kg/m³.

Thickness and density of the multi-layer board is determined according to the European Standard (“EN”) 323, published in 1993. Humidity of the multi-layer board is determined according to EN 322, published in 1993. Flexural modulus of elasticity and modulus of rupture of the multi-layer board is determined according to EN 310, published in 1993. Thickness swell percent in water after 2 hours and 24 hours of the multi-layer board is determined according to EN 317, published in 1993. Water absorption is determined according to EN 317, published in 1993. Moisture of the multi-layer board is determined according to EN 322, published in 2005. Internal bond strength is determined according to EN 319, published in 1993. Surface soundness of the multi-layer board, which measures the amount of force required to delete the multi-layer board at the interface of the core layer and at least one of the face layers, is determined according to EN 311, published in 1993. Results are shown in Table 4. The results show that multi-layer boards that include vegetable flours such as REC, RWF, and RM, surprisingly and unexpectedly, show equivalent performance to multi-layer boards that include flours such as soy flours, sunflower flours, or maize meal all of which have a higher protein content than REC, RWF, and RM.

Additionally, the Examples described herein do not include the presence of a wax (e.g., paraffin) additive in any of the face layers, core layer, or a combination thereof. It is understood by one of ordinary skill in the art that a wax additive can be added to any of the face layers, core layer, or a combination thereof and that this addition can help to improve the water swelling and water absorption values (at both 2 hours and 24 hours) reported in Table 5.

TABLE 5

| Example | 1.1 | 1.2 | 1.3 | 1.4 | 1.5 | 1.6 | 1.7 | 1.8 | 1.9 | 1.1 [symbol] |
|---|---|---|---|---|---|---|---|---|---|---|
| Moisture percentage of FLWP | 10.2 | 10.8 | 12.1 | 11.9 | 11.7 | 12 | 11.8 | 11.3 | 11.5 | 10. [symbol] |
| Moisture percentage of CLWP | 6.2 | 6 | 6.1 | 6.3 | 6.1 | 5.7 | 6 | 6.1 | 6.66 | 5.9 [symbol] |
| Panel thickness (before | 17.84 | 17.62 | 17.76 | 17.74 | 17.74 | 17.68 | 17.61 | 17.65 | 17.69 | 17.73 |
| sanding) (mm) | | | | | | | | | | |
| Thickness after conditioning | 17.88 | 17.52 | 17.63 | 17.63 | 17.64 | 17.56 | 17.50 | 17.56 | 17.60 | 17.62 |
| (mm) | | | | | | | | | | |
| Thickness at test (mm) | 17.46 | 17.41 | 17.42 | 17.36 | 17.41 | 17.42 | 17.41 | 17.40 | 17.40 | 17.44 |
| Panel density (kg/m³⁾) | 699 | 699 | 709 | 697 | 706 | 714 | 715 | 711 | 717 | 694 |
| MOR (N/mm²) | 15.5 | 13.2 | 12.2 | 13.3 | 12.0 | 13.2 | 13.9 | 13.8 | 14.1 | 13.1 |
| MOE (N/mm²) | 3321 | 2792 | 2649 | 2859 | 2687 | 2770 | 2814 | 2858 | 2889 | 2709 |
| Internal bond (N/mm²) | 0.55 | 0.54 | 0.53 | 0.52 | 0.54 | 0.53 | 0.53 | 0.56 | 0.57 | 0.50 |
| Thickness swelling (%), 2 h | 33.5 | 32.6 | 33.8 | 32.9 | 32.5 | 32.1 | 31.8 | 31.4 | 30.3 | 33.2 |
| Thickness swelling (%), 24 h | 41.9 | 39.2 | 40.6 | 40.1 | 39.2 | 38.6 | 38.6 | 37.8 | 36.5 | 39.7 |
| Water absorption (%), 2 h | 84.6 | 87.4 | 85.1 | 87.3 | 85.0 | 83.1 | 81.1 | 81.7 | 80.4 | 100.6 |
| Water absorption (%), 24 h | 98.3 | 99.5 | 97.5 | 100.1 | 96.9 | 95.2 | 94.8 | 95.9 | 92.5 | 100.6 |
| Surface Soundness (N/mm²) | 1.15 | 0.97 | 1.02 | 1.13 | 1.08 | 1.08 | 1.23 | 1.04 | 1.18 | 0.95 |
| Moisture of panel (%) | 8.7 | 9.0 | 9.0 | 8.9 | 8.9 | 8.9 | 8.8 | 9.0 | 8.9 | 8.9 |

[symbol]

indicates data missing or illegible when filed

### Example 5

Single-layer particle boards having dimensions 460 mm long×440 mm wide×9.8 to 10.0 mm thick are produced. Production includes resinating wood particles with a two-component glue including a vegetable flour (e.g., rapeseed meal, rapeseed white flakes, Prolia 200/90, etc) and a CL4740 crosslinker. The wood chips are homogenized in a blender with rotating arms (e.g., Lödige blender, available from Bickel & Wolf GmbH, Purkesdorf Austria). The calculated amount of vegetable flour is added at a dose indicated in Table 5. After about 30 seconds of blending, the calculated amount of crosslinker, as indicated in Table 5, is sprayed on the face layer wood particles and vegetable flour mixture while blending. Wood particle moisture is adjusted by spraying additional water in order to achieve the calculated target moisture level of 12%, as calculated above with respect to Example 1. The single-layer particle board was formed by curing for 120 seconds at a temperature of 220° C.

After conditioning the particle boards for one week at 20° C. and 65% relative humidity (r.h.), test specimens are cut according to the EN 326-1 standard. Specimens are again conditioned for one week at 20° C. and 65% relative humidity (r.h.), before testing. The single-layer boards were 460 mm long×440 mm wide×17.5 mm thick. The single-layer boards were sanded to a thickness of 16 mm. The target density of the single-layer boards was 650 kg/m³+/−10 kg/m³.

Thickness and density of the single-layer board is determined according to the EN 323, published in 1993. Humidity of the single-layer board is determined according to EN 322, published in 1993. Flexural modulus of elasticity and modulus of rupture of the multi-layer board is determined according to EN 310, published in 1993. Thickness swell percent in water after 2 hours and 24 hours of the single-layer board is determined according to EN 317. Moisture of the multi-layer board is determined according to EN 322, published in 2005. published in 1993. Internal bond strength is determined according to EN 319, published in 1993. Surface soundness of the single-layer board, which measures the amount of force required to delete the single-layer board at the interface of the core layer and at least one of the face layers, is determined according to EN 311, published in 1993. Results are shown in Table 6.

TABLE 6

| | | | Full Fat | | | |
|---|---|---|---|---|---|---|
| Vegetable | Prolia | Sopro | Soybean | | | |
| Flour | 200/90 | UTB 200 | Flour, | REC | RWF | RM |
| Dry | 17.3 | 17.2 | 12.6 | 10.3 | 14.4 | 12.2 |
| Strength | | | | | | |
| kgF | | | | | | |
| Modulus | 3.27 | 3.37 | 2.37 | 1.98 | 2.74 | 2.29 |
| of Rupture | | | | | | |
| (MOR) | | | | | | |
| N/mm2 | | | | | | |
| Modulus | 395 | 431 | 296 | 295 | 356 | 323 |
| of | | | | | | |
| Elasticity | | | | | | |
| (MOE) | | | | | | |
| N/mm2 | | | | | | |
| Internal | 0.081 | 0.089 | 0.075 | 0.075 | 0.065 | 0.032 |
| Bond | | | | | | |
| Strength | | | | | | |
| N/mm2 | | | | | | |
| Thickness | 65% | 67% | 69% | 91% | 85% | 79% |
| Swell % | | | | | | |
| (24 hours) | | | | | | |
| Particle | 10.0 | 9.8 | 10.0 | 9.9 | 9.9 | 10.0 |
| Board | | | | | | |
| Thickness | | | | | | |
| (mm) | | | | | | |
| Particle | 609 | 622 | 611 | 618 | 612 | 609 |
| Board | | | | | | |
| Density | | | | | | |
| kg/m3 | | | | | | |
| Parts | 9.0 | 9.0 | 9.0 | 9.0 | 9.0 | 9.0 |
| Binder per | | | | | | |
| 100 Parts | | | | | | |
| Dry Wood | | | | | | |
| Particles | | | | | | |
| wt % | 5.5 | 5.5 | 5.5 | 5.5 | 5.5 | 5.5 |
| vegetable | | | | | | |
| flour | | | | | | |
| CL4740 | 3.5 | 3.5 | 3.5 | 3.5 | 3.5 | 3.5 |
| (parts per | | | | | | |
| 100 parts | | | | | | |
| dry wood | | | | | | |
| particle) | | | | | | |
| Wt % | 12.0% | 12.0% | 12.0% | 12.0% | 12.0% | 12.0% |
| Moisture | | | | | | |
| in Particle | | | | | | |
| Board | | | | | | |

The results of Example 5 show that single-layer particle boards including rapeseed (e.g., rapeseed expeller cake, rapeseed white flake, and rapeseed meal) do not perform as well as those including soy (e.g., Prolia 200/90, Sopro UTB200, and Fat SF). Surprisingly and unexpectedly, however, as shown in Example 2 multi-layer particle boards including rapeseed in the face layers performs equivalently to multi-layer particle boards using soy in the face layers.

The data shown in the Examples herein is generated using laboratory-scale experiments. As such, some of the data may outperform corresponding products that are produced at the industrial scale.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### EXEMPLARY ASPECTS

The following exemplary aspects are provided, the numbering of which is not to be construed as designating levels of importance:

Aspect 1 provides a multi-layer engineered wood product, comprising:
a first face layer;
a second face layer; and
a core layer disposed between the first face layer and the second face layer; wherein the first face layer and the second face layer independently comprise:
   a plurality of wood particles; and
   a reaction product of a binder reaction mixture dispersed about the plurality of wood particles, the binder reaction mixture being present in a range of from 5 parts to 20 parts per 100 parts of a dry weight of the plurality of wood particles, the binder reaction mixture and wood particles together having a moisture content in a range of 5 wt % to 20 wt % and comprising:
      an aqueous portion comprising a crosslinker in a range of from 20 wt % to 60 wt % based on the dry weight of the binder reaction mixture; and
      a polypeptide-containing component that is present in a range of from 40 wt % to 80 wt % based on the dry weight of the binder reaction mixture, the polypeptide-containing component comprising a milled rapeseed flour, milled sunflower flour, or a mixture thereof; and
   the core layer comprises a urea-formaldehyde based binder, a pre-polymerized methylene diphenyl diisocyanate based binder, a polyamidoamine-epichlorohydrin resin, a melamine-urea-formaldehyde based binder, or a mixture thereof.

Aspect 2 provides the multi-layer engineered wood product of Aspect 1, wherein the binder reaction mixture of the first face layer and the binder reaction mixture and wood particles together of the second face layer have the same chemical composition and optionally comprise the same moisture content.

Aspect 3 provides the multi-layer engineered wood product of any one of Aspects 1 or 2, wherein one of the binder reaction mixture of the first face layer and the binder reaction mixture and wood particles together of the second face layer have different chemical compositions and optionally comprise a different moisture content.

Aspect 4 provides the multi-layer engineered wood product of any one of Aspects 1-3, wherein a protein content of the polypeptide-containing component is less than a protein content of a soy flour.

Aspect 5 provides the multi-layer engineered wood product of any one of Aspects 1-4, wherein a protein content of the polypeptide-containing component is less than a protein content of a corn flour.

Aspect 6 provides the multi-layer engineered wood product of any one of Aspects 1-5, wherein a protein dispersibility index of the polypeptide-containing component is in a range of from 3% to 95%.

Aspect 7 provides the multi-layer engineered wood product of any one of Aspects 1-6, wherein a protein dispersibility index of the polypeptide-containing component is in a range of from 4% to 50%.

Aspect 8 provides the multi-layer engineered wood product of any one of Aspects 1-7, wherein a protein dispersibility index of the polypeptide-containing component is in a range of from 4% to 37%.

Aspect 9 provides the multi-layer engineered wood product of Aspect 8, wherein a protein dispersibility index of the polypeptide-containing component is in a range of from 50% to 95%.

Aspect 10 provides the multi-layer engineered wood product of any one of Aspects 1-9, wherein the polypeptide-containing component comprises a milled flour comprising a distribution of particles having a d95 in a range of from 50 μm to 120 μm.

Aspect 11 provides the multi-layer engineered wood product of any one of Aspects 1-10, wherein the polypeptide-containing component comprises a milled flour comprising a distribution of particles having a d95 in a range of from 60 μm to 98 μm.

Aspect 12 provides the multi-layer engineered wood product of any one of Aspects 1-11, wherein the polypeptide-containing component comprises a milled flour comprising a distribution of particles having a d10 is less than 5 μm, less than 4 μm, and preferably less than 3 μm.

Aspect 13 provides the multi-layer engineered wood product of any one of Aspects 1-12, wherein the moisture content of the binder reaction mixture and wood particles together is in a range of 9 wt % to 15 wt %.

Aspect 14 provides the multi-layer engineered wood product of Aspects 1-13, wherein a pH of the aqueous portion is greater than 2 and less than 7.

Aspect 15 provides the multi-layer engineered wood product of any one of Aspects 1-14, wherein a pH of the aqueous portion is from 3 to 6.

Aspect 16 provides the multi-layer engineered wood product of any one of Aspects 1-15, wherein a pH of the aqueous portion is from 3.5 to 4.5.

Aspect 17 provides the multi-layer engineered wood product of any one of Aspects 1-16, wherein the polypeptide-containing component is in a range of from 50 wt % to 70 wt %, based on a dry weight of the binder reaction mixture.

Aspect 18 provides the multi-layer engineered wood product of any one of Aspects 1-17, wherein polypeptide-containing component is in a range of from 60 wt % to 65 wt %, based on a dry weight of the binder reaction mixture.

Aspect 19 provides the multi-layer engineered wood product of any one of Aspects 1-18, wherein the binder reaction mixture of each individual layer is present in a range of from 5 parts to 20 parts per 100 parts of the dry weight of the plurality of wood particles of each of the first face layer, the second face layer, the core layer, or a combination thereof.

Aspect 20 provides the multi-layer engineered wood product of any one of Aspects 1-19, wherein the binder reaction mixture of each individual layer is present in a range of from 8 parts to 17 parts per 100 parts of the dry weight of the plurality of wood particles of each of the first face layer, the second face, layer, the core layer, or a combination thereof.

Aspect 21 provides the multi-layer engineered wood product of any one of Aspects 1-20, wherein the crosslinker comprises a polyamide-epichlorohydrin-based crosslinker.

Aspect 22 provides the multi-layer engineered wood product of any one of Aspects 1-21, wherein a modulus of rupture of the multi-layer engineered wood product is in a range of from 10 N/mm² to 20 N/mm².

Aspect 23 provides the multi-layer engineered wood product of any one of Aspects 1-22, wherein a modulus of rupture of the multi-layer engineered wood product is in a range of from 12 N/mm² to 14 N/mm².

Aspect 24 provides the multi-layer engineered wood product of any one of Aspects 1-23, wherein a thickness swell percentage of the multi-layer engineered wood product measured after soaking the multi-layer engineered wood product in water for two hours is in a range of from 5% to 40%.

Aspect 25 provides the multi-layer engineered wood product of any one of Aspects 1-24, wherein a thickness swell percentage of the multi-layer engineered wood product measured after soaking the multi-layer engineered wood product in water for two hours is in a range of from 15% to 35% (for example, 20% to 35%).

Aspect 26 provides the multi-layer engineered wood product of any one of Aspects 1-25, wherein a thickness swell percentage of the multi-layer engineered wood product measured after soaking the multi-layer engineered wood product in water for twenty-four hours is in a range of from 5% to 50%.

Aspect 27 provides the multi-layer engineered wood product of any one of Aspects 1-26, wherein a thickness swell percentage of the multi-layer engineered wood product measured after soaking the multi-layer engineered wood product in water for twenty-four hours is in a range of from 15% to 45% (for example, 35% to 42%).

Aspect 28 provides the multi-layer engineered wood product of any one of Aspects 1-27, wherein a modulus of elasticity of the multi-layer engineered wood product is in a range of from 1,000 N/mm² to 4,000 N/mm².

Aspect 29 provides the multi-layer engineered wood product of any one of Aspects 1-28, wherein a modulus of elasticity of the multi-layer engineered wood product is in a range of from 1,500 N/mm² to 1,900 N/mm².

Aspect 30 provides the multi-layer engineered wood product of any one of Aspects 1-29, wherein an internal bond strength of the multi-layer engineered wood product is in a range of from 0.3 N/mm² to 0.7 N/mm².

Aspect 31 provides the multi-layer engineered wood product of any one of Aspects 1-30, wherein an internal bond strength of the multi-layer engineered wood product is in a range of from 0.4 N/mm² to 0.6 N/mm².

Aspect 32 provides the multi-layer engineered wood product of any one of Aspects 1-31, wherein a moisture content of the core layer is in a range of from 2 wt % to 15 wt %.

Aspect 33 provides the multi-layer engineered wood product of any one of Aspects 1-32, wherein a moisture content of the core layer is in a range of from 3 wt % to 15 wt %.

Aspect 34 provides the multi-layer engineered wood product of any one of Aspects 1-33, wherein a moisture content of the core layer is in a range of from 4 wt % to 6 wt %.

Aspect 35 provides the multi-layer engineered wood product of any one of Aspects 1-34, wherein a moisture content of each of the binder reaction mixtures and wood particles together of the first face layer and the second face layer are independently in a range of from 4 wt % to 20 wt %.

Aspect 36 provides the multi-layer engineered wood product of any one of Aspects 1-35, wherein a moisture content of each of the binder reaction mixtures and wood particles together of the first face layer and the second face layer are independently in a range of from 6 wt % to 15 wt %.

Aspect 37 provides the multi-layer engineered wood product of any one of Aspects 1-36, wherein a moisture content of each of the binder reaction mixtures and wood particles together of the first face layer and the second face layer are independently in a range of from 10 wt % to 14 wt %.

Aspect 38 provides the multi-layer engineered wood product of any one of Aspects 1-37, wherein a density of the multi-layer engineered wood product is in a range of from 500 kg/m³ to 850 kg/m³.

Aspect 39 provides the multi-layer engineered wood product of any one of Aspects 1-38, wherein a density of the multi-layer engineered wood product is in a range of from 630 kg/m³ to 750 kg/m³.

Aspect 40 provides the multi-layer engineered wood product of any one of Aspects 1-39, wherein the reaction product of the binder reaction mixture is homogenously distributed about the plurality of wood particles.

Aspect 41 provides the multi-layer engineered wood product of any one of Aspects 1-40, wherein
the first and second face layers independently comprise from 20 wt % to 40 wt % of a combined weight of the first face layer, second face layer, and core layer; and
the core layer comprises from 60 wt % to 80 wt % of the combined weight of the first face layer, second face layer, and core layer.

Aspect 42 provides the multi-layer engineered wood product of any one of Aspects 1-41, wherein the plurality of wood particles comprises virgin wood, recycled wood or a mixture thereof.

Aspect 43 provides the multi-layer engineered wood product of Aspect 42, wherein the plurality of wood particles of the first face layer and the second face layer have an average major dimension that is smaller than the average major dimension of the wood particles of the core layer.

Aspect 44 provides the multi-layer engineered wood product of any one of Aspects 42 or 43, wherein individual wood particles of the plurality of wood particles comprise an aspect ratio (length:width) that is greater than 1.

Aspect 45 provides the multi-layer engineered wood product of any one of Aspects 1-44, wherein the wood particles of the first face layer, the second face layer, or both comprise:
a width in a range of from 0.5 mm to 1.5 mm; and
a length in a range of from 1 mm to 5 mm.

Aspect 46 provides the multi-layer engineered wood product of any one of Aspects 1-45, wherein the wood particles of the first face layer, the second face layer, or both comprise:
a width in a range of from 0.6 to 1; and
a length in a range of from 2 mm to 5 mm.

Aspect 47 provides the multi-layer engineered wood product of any one of Aspects 1-46, wherein the wood particles of the core layer comprise:
a width in a range of from 1.5 mm to 5 mm; and
a length in a range of from 5 mm to 15 mm.

Aspect 48 provides the multi-layer engineered wood product of any one of Aspects 1-47, wherein the wood particles of the core layer:
a width in a range of from 1.5 mm to 3 mm; and
a length in a range of from 8 mm to 12 mm.

Aspect 49 provides the multi-layer engineered wood product, of any one of Aspects 1-48, further comprising a wax additive dispersed about the first face layer, the second face layer or both and optionally dispersed about the core layer.

Aspect 50 provides the multi-layer engineered wood product of any one of Aspects 1-49, wherein the crosslinker in a range of from 30 wt % to 50 wt % based on the dry weight of the binder reaction mixture.

Aspect 51 provides the multi-layer engineered wood product of any one of Aspects 1-50, wherein the crosslinker in a range of from 35 wt % to 45 wt % based on the dry weight of the binder reaction mixture.

Aspect 52 provides the multi-layer engineered wood product of any one of Aspects 1-51, wherein a viscosity of the binder reaction mixture of the first face layer, the binder reaction mixture of the second face layer of both are in a range of from 150 mPas to 250 mPas measured at a temperature of 22° C.

Aspect 53 provides the multi-layer engineered wood product of any one of Aspects 1-52, wherein a viscosity of the binder reaction mixture of the first face layer, the binder reaction mixture of the second face layer of both are in a range of from 160 mPas to 180 mPas measured at a temperature of 22° C.

Aspect 54 provides the multi-layer engineered wood product of any one of Aspects 1-53, wherein a dry solids content of the binder reaction mixture of the first face layer, the binder reaction mixture of the second face layer, or both are in a range of from 50% to 90%.

Aspect 55 provides the multi-layer engineered wood product of any one of Aspects 1-54, wherein a dry solids content of the binder reaction mixture of the first face layer, the binder reaction mixture of the second face layer, or both are in a range of from 60% to 80%.

Aspect 56 provides the multi-layer engineered wood product of any one of Aspects 1-55, wherein a dry solids content of the binder reaction mixture of the core layer is in a range of from 50% to 100%.

Aspect 57 provides the multi-layer engineered wood product of any one of Aspects 1-56, wherein a dry solids content of the binder reaction mixture of the core layer is in a range of from 60% to 90%.

Aspect 58 provides the multi-layer engineered wood product of any one of Aspects 1-57, wherein the polypeptide-containing component of the first face layer, the second layer or both, independently comprise as protein content in a range of from 20 wt % to 45 wt %.

Aspect 59 provides the multi-layer engineered wood product of any one of Aspects 1-58, wherein the polypeptide-containing component of the first face layer, the second layer or both, independently comprise as protein content in a range of from 25 wt % to 40 wt %.

Aspect 60 provides the multi-layer engineered wood product of any one of Aspects 1-59, wherein the polypeptide-containing component of the first face layer, the second layer or both, independently comprise as protein content in a range of from 27 wt % to 37 wt %.

Aspect 61 provides the multi-layer engineered wood product of any one of Aspects 1-60, wherein the multi-layer engineered wood product is a particle board or a fiber board.

Aspect 62 provides the multi-layer engineered wood product of Aspect 61, wherein the fiber board is an oriented strand board.

Aspect 63 provides a method of making a multi-layer engineered wood product, the method comprising:
(a) combining a first plurality of wood particles with a polypeptide-containing component comprising a rapeseed flour, sunflower flour, or a mixture thereof to produce a first mixture;
(b) combining the first mixture produced at (a) with an aqueous formulation comprising a crosslinker to obtain a second mixture;
(c) combining a second plurality of wood particles with a urea-formaldehyde based binder, a pre-polymerized methylene diphenyl diisocyanate based binder, a polyamidoamine-epichlorohydrin resin, a melamine-urea-formaldehyde based binder, or a mixture thereof to form a third mixture;
(d) combining a third plurality of wood particles with a polypeptide-containing component comprising a rapeseed flour, sunflower flour, or a mixture thereof to produce a fourth mixture;
(e) combining the fourth mixture produced at (d) with an aqueous portion comprising a crosslinker to obtain a fifth mixture;
(f) stacking the second mixture, third mixture, and fifth mixture to form a multi-layer engineered wood precursor; and
(g) curing the multi-layer engineered wood precursor, to form the multi-layer engineered wood product.

Aspect 64 provides the method of Aspect 63, wherein curing at (g) is performed at a temperature of 180° C. to 240° C.

Aspect 65 provides the method of any one of Aspects 63 or 64, wherein curing at (g) is performed at a temperature of 190° C. to 230° C.

Aspect 66 provides the method of any one of Aspects 63-65, wherein curing at (g) is performed at a temperature of 190° C. to 220° C.

Aspect 67 provides the method of any one of Aspects 63-66, wherein the aqueous formulation of b) and d) are sprayed to the first mixture and fourth mixture, respectively.

Aspect 68 provides the method of any one of Aspects 63-37, wherein combining the first plurality of wood particles with the polypeptide-containing component of a) and combining the third plurality of wood particles with the polypeptide-containing component of d) comprises using a mechanical impact mill.

Aspect 69 provides the method of any one of Aspects 63-38, further comprising adding water to the first mixture, the second mixture, the third mixture, the fourth mixture, the fifth mixture, or a combination thereof.

Aspect 70 provides the method of any one of Aspects 63-69, further comprising pressing the rapeseed flour and optionally extracting at least a portion of any oil in the rapeseed flour.

1. A multi-layer engineered wood product, comprising:
a first face layer;
a second face layer; and
a core layer disposed between the first face layer and the second face layer; wherein the first face layer and the second face layer independently comprise:
a plurality of wood particles; and
a reaction product of a binder reaction mixture dispersed preferably homogenously distributed, about the plurality of wood particles, the binder reaction mixture being present in a range of from 5 parts to 20 parts per 100 parts of a dry weight of the plurality of wood particles, a moisture content of the binder reaction mixture and the plurality of wood particles being in a range of 5 wt % to 20 wt % and comprising:
an aqueous portion comprising a crosslinker in a range of from 20 wt % to 60 wt % based on the dry weight of the binder reaction mixture; and
a polypeptide-containing component that is present in a range of from 40 wt % to 80 wt % based on the dry weight of the binder reaction mixture, the polypeptide-containing component comprising a milled rapeseed flour, milled sunflower flour, or a mixture thereof; and
the core layer comprises a urea-formaldehyde based binder, a pre-polymerized methylene diphenyl diisocyanate based binder, a polyamidoamine-epichlorohydrin resin, a melamine-urea-formaldehyde based binder, or a mixture thereof.

2. The multi-layer engineered wood product of claim 1, wherein the binder reaction mixture and wood particles together of the first face layer and the binder reaction mixture of the second face layer have the same or different chemical composition and optionally comprise the same or different moisture content.

3. (canceled)

4. The multi-layer engineered wood product of claim 1, wherein
(i). a protein content of the polypeptide-containing component is less than a protein content of a soy flour or a protein content of a corn flour; and/or
(ii). a protein di ty index of the polypeptide-containing component is in a range of from 3% to 95%.

5.-9. (canceled)

10. The multi-layer engineered wood product of claim 1, wherein the polypeptide-containing component comprises a milled flour comprising a distribution of particles having:
(i). a d95 in a range of from 50 μm to 120 μm; and/or
(in). a d10 is less than 5 am less than 4 μm, and preferably less than 3 μm.

11.-13. (canceled)

14. The multi-layer engineered wood product of claim 1, wherein a pH of the aqueous portion is greater than 2 and less than 7.

15.-18. (canceled)

19. The multi-layer engineered wood product of claim 1, wherein the binder reaction mixture of each individual layer is present in a range of from 5 parts to 20 parts per 100 parts of the dry weight of the plurality of wood particles of each of the first face layer, the second face layer, the core layer, or a combination thereof.

20. (canceled)

21. The multi-layer engineered wood product of claim 1, wherein
(i). the crosslinker comprises a polyamide-epichlorohydrin-based crosslinker; and/or
(ii). the crosslinker range of from 30 wt % to 50 wt % based on the dry weight of the binder reaction mixture.

22. The multi-layer engineered wood product of claim 1, wherein
(i). a modulus of rupture of the multi-layer engineered wood product is in a range of from 10 N/mm² to 20 N/mm²;
(ii). a thickness swell percentage of the multi-layer engineered wood product measured after soaking the multi-layer engineered wood product in water for two hours is in a range of from 5% to 40%;
(iii). a thickness swell percentage of the multi-layer engineered wood product measured after soaking the multi-layer engineered wood product in water for twenty-four hours is in a range of from to 5% 50%;
(iv). a modulus of elasticity of the multi-layer engineered wood product is in a range of from 1,000 N/mm² to 4,000 N/mm²;
(v). an internal bond strength of the multi-layer engineered wood product is in a range of from 0.3 N/mm² to 0.7 N/mm² and/or
(vi). a density of the multi-layer engineered wood product is in a range of from 500 kg/m³ to 850 kg/m³.

23.-31. (canceled)

32. The multi-layer engineered wood product of claim 1, wherein
(i). a moisture content of the core layer is in a range of from 2 wt % to 15 wt %; and/or
(ii). a moisture content of each of the binder reaction mixtures and wood particles together of the first face layer and the second face layer are independently in a range of from 4 wt % to 20 wt %.

33.-40. (canceled)

41. The multi-layer engineered wood product of claim 1, wherein
the first and second face layers independently comprise from 20 wt % to 40 wt % of a combined weight of the first face layer, second face layer, and core layer; and
the core layer comprises from 60 wt % to 80 wt % of the combined weight of the first face layer, second face layer, and core layer.

42. The multi-layer engineered wood product of claim 1, wherein
(i). the plurality of wood particles comprises virgin wood, recycled wood or a mixture thereof;
(ii). the plurality of wood particles of the first face layer and the second face layer have an average major dimension that is smaller than the average major dimension of the wood particles of the core layer; and/or
(iii). individual wood particles of the plurality of wood particles comprise an aspect ratio length:width) that is greater than 1.

43. (canceled)

44. (canceled)

45. The multi-layer engineered wood product of claim 1, wherein
(i). the wood particles of the first face layer, the second face layer, or both comprise:
a width in a range of from 0.5 mm to 1.5 mm; and
a length in a range of from 1 mm to 5 mm, and/or
(ii). the wood particles of the core layer comprise:
a width in a range of from 1.5 mm to 5 mm; and
a length in a range of from 5 mm to 15 mm.

46.-48. (canceled)

49. The multi-layer engineered wood product claim 1, further comprising a wax additive dispersed about the first face layer, the second face layer or both and optionally dispersed about the core layer.

50. (canceled)

51. (canceled)

52. The multi-layer engineered wood product of claim 1, wherein a viscosity of the binder reaction mixture of the first face layer, the binder reaction mixture of the second face layer of both are in a range of from 150 mPas to 250 mPas measured at a temperature of 22° C.

53. (canceled)

54. The multi-layer engineered wood product of claim 1, wherein
(i). a dry solids content of the binder reaction mixture of the first face layer, the binder reaction mixture of the second face layer, or both are in a range of from 50% to 90%; and/or
(ii). a dry solids content of the binder reaction mixture of the core layer is in a range of from 50% to 100%.

55.-57. (canceled)

58. The multi-layer engineered wood product of claim 1, wherein the polypeptide-containing component of the first face layer, the second layer or both, independently comprise as protein content in a range of from 20 wt % to 45 wt %.

59. (canceled)

60. (canceled)

61. The multi-layer engineered wood product of claim 1, wherein the multi-layer engineered wood product is a particle board or a fiber board.

62. The multi-layer engineered wood product of claim 61, wherein the fiber board is an oriented strand board.

63. A method of making a multi-layer engineered wood product, the method comprising:
(a) combining a first plurality of wood particles with a polypeptide-containing component comprising a rapeseed flour, sunflower flour, or a mixture thereof to produce a first mixture;
(b) combining the first mixture produced at (a) with an aqueous formulation comprising a crosslinker to obtain a second mixture;
(c) combining a second plurality of wood particles with a urea-formaldehyde based binder, a pre-polymerized methylene diphenyl diisocyanate based binder, a polyamidoamine-epichlorohydrin resin, a melamine-urea-formaldehyde based binder, or a mixture thereof to form a third mixture;
(d) combining a third plurality of wood particles with a polypeptide-containing component comprising a rapeseed flour, sunflower flour, or a mixture thereof to produce a fourth mixture;
(e) combining the fourth mixture produced at (d) with an aqueous portion comprising a crosslinker to obtain a fifth mixture;
(f) stacking the second mixture, third mixture, and fifth mixture to form a multi-layer engineered wood precursor; and
(g) curing the multi-layer engineered wood precursor, to form the multi-layer engineered wood product.

64. The method of claim 63, wherein
(i). curing at (g) is performed at a temperature of 180° C. to 240° C.;
(ii), the aqueous formulation of b) and d) are sprayed to the first mixture and fourth mixture respectively; and/or
(iii). combining the first plurality of wood particles with the polypeptide-containing component of a) and combining the third plurality of wood particles with the polypeptide-containing component using a mechanical impact mill.

65.-68. (canceled)

69. The method of claim 63, further comprising
(i). adding water to the first mixture, the second mixture, the third mixture, the fourth mixture, the fifth mixture, or a combination thereof;
(ii). pressing the rapeseed flour and optionally extracting at least a portion of any oil in the rapeseed flour.

70. (canceled)
